(19) United States
(12) Patent Application Publication
(10) Pub. No.: US 2012/0020454 A1
(43) Pub. Date: Jan. 26, 2012

(54) Radiation imaging system and collimator unit

(75) Inventor: Dai Murakoshi, Kanagawa (JP)

(73) Assignee: FUJIFILM Corporation, Tokyo (JP)

(21) Appl. No.: 13/137,069

(22) Filed: Jul. 19, 2011

(30) Foreign Application Priority Data
Jul. 23, 2010 (JP) 2010-165874

(51) Int. Cl. G01N 23/04; G21K 1/02

(52) U.S. Cl. 378/36; 378/147

(57) ABSTRACT

A collimator unit includes a filter set for regulating a spectrum of X-rays emitted from an X-ray source, and a source grating having plural X-ray shielding portions and X-ray transmitting portions. The X-ray shielding portions and X-ray transmitting portions extend in a y direction parallel to a rotational axis of a rotating anode of the X-ray source, and are alternately arranged in an x direction orthogonal to an optical axis direction (z direction) of the X-rays. The intensity of the X-rays is reduced in the y direction by a heel effect. However, further reduction in the intensity of the X-rays by vignetting does not occur in the y direction. Since the filter set is disposed upstream from the source grating in an application direction of the X-rays, the source grating forms arrayed narrow focuses of X-ray beams from the X-rays disturbed by a filter element.

### BACKGROUND OF THE INVENTION

1. Field of the Invention

The present invention relates to a collimator unit used in a radiation tube of a rotating anode type, and a radiation imaging system having the collimator unit.

2. Description Related to the Prior Art

An X-ray tube used in an X-ray imaging system, which images an object with X-rays, is constituted of an anode and a cathode disposed oppositely to each other in a vacuum vessel. To produce the X-rays, thermoelectrons as an electron beam emitted from a filament of the cathode are made collide against the anode (target). A collision point of the electron beam on the anode is defined as an X-ray focus, from which the X-rays radiate.

The X-ray tube has a stationary anode type and a rotating anode type. The X-ray imaging system generally uses a rotating anode type X-ray tube that can emit higher power X-rays than those from a stationary anode type X-ray tube. As shown in FIGS. 16 and 17, in a rotating anode type X-ray tube, while a disk-shaped rotating anode 130 is rotated, an electron beam emitted from a filament 131a of a cathode 131 collides against an inclined target surface 130a provided in the rim of the rotating anode 130 to produce X-rays. The X-rays radiate from an X-ray focus 132 being a collision point of the electron beam. The intensity of the X-rays is reduced with approaching the target surface 130a of the anode 130 in an extension (conical plane enclosed by alternate long and short dashed lines in FIG. 16) of radiation in a plane formed by an axis of the electron beam emitted from the cathode 131 and an optical axis of the X-rays. This phenomenon about intensity variation of the X-rays is known as a heel effect.

In a rotating anode type X-ray tube, since the deflection of the rotation axis occurs in rotational motion, the nominal size (effective size) of an X-ray focus is increased. Increase in the size of the X-ray focus degrades sharpness of an X-ray image. Thus, the size of the X-ray focus should be as small as possible. Particularly, an image magnification method in which an X-ray image detector is disposed away from an object requires a small X-ray focus. Also, development of phase contrast imaging has proceeded in recent years, by which an X-ray image detector detects phase change of X-rays caused by refraction of the X-rays in passing through an object and an image is created based on the phase change. The phase contrast imaging requires a small X-ray focus too.

An X-ray imaging system using an X-ray Talbot interferometer, which includes two transmission gratings and an X-ray image detector, is known as a kind of X-ray phase contrast imaging system (refer to Japanese Patent Laid-Open Publication No. 2008-200359, for example). It is also known, for example, by U.S. Pat. No. 7,889,838 that a source grating having a linear periodic pattern of alternate X-ray shielding and transmitting portions is disposed in front of an X-ray source. The source grating partly shields X-rays emitted from the X-ray source, in order to reduce an effective focus size and form a group of many narrow line sources (distributed light source). The Japanese Patent Laid-Open Publication No. 2008-200359 and the U.S. Pat. No. 7,889,838 also describe a filter element disposed in an optical path of X-rays to remove an X-ray component having wavelengths other than a specific wavelength and enhance monochromaticity.

X-rays emitted from an X-ray source are not a parallel beam but a cone beam that propagates with some angular divergence originated in an X-ray focal spot. For this reason, if a source grating 135 is disposed in front of the X-ray source, as shown in FIG. 18, the X-rays are partly shaded by X-ray shielding portions 135a in upper and lower portions of the source grating 135. Thus, as shown in the right of FIG. 18, the intensity of the X-rays is reduced from an original state shown by a chain double-dashed line to a state shown by a solid line. This causes reduction in a signal-to-noise ratio in upper and lower portions of an image produced by an X-ray image detector. Particularly, if the heel effect occurs in a periodic pattern direction of the X-ray shielding portions 135a of the source grating 135, the intensity of the X-rays is further reduced to a state shown by a short dashed line. Therefore, the signal-to-noise ratio is significantly reduced in the upper and lower portions. This leads to poorer image quality, and adversely affects medical diagnosis.

Furthermore, in the U.S. Pat. No. 7,889,838, the filter element is disposed downstream from the source grating along an optical axis direction of the X-rays. Accordingly, the filter element scatters X-ray photons from the distributed light source formed by the source grating in a pseudo manner, and disturbs an X-ray wavefront. This makes the focus size blurry, and causes degradation of the coherence of the X-rays in each distributed light source, resulting in deterioration in sharpness of an image.

### SUMMARY OF THE INVENTION

An object of the present invention is to provide a radiation imaging system that can produce an image with high quality, by preventing attenuation of X-rays due to vignetting of a source grating and a heel effect of an X-ray tube, and preventing blurriness of a focus size and degradation of the coherence of the X-rays in each distributed light source due to adoption of a filter.

To achieve the above and other objects, a radiation imaging system according to the present invention includes a radiation tube, a source grating having a plurality of radiation shielding portions, and a radiation image detector. The radiation tube produces a radiation upon application of an electron beam from a filament to a rotating anode. The radiation shielding portions extend in a first direction orthogonal to an optical axis of the radiation and parallel to a rotational axis of the rotating anode, and are arranged at a predetermined pitch along a second direction orthogonal to the first direction. The radiation image detector is opposed to the radiation tube, and detects the radiation passed through an object.

The radiation imaging system may further include a filter disposed between the radiation tube and the source grating. The radiation passes through the source grating after having passed through the filter.

The radiation imaging system may further include a collimator unit having the source grating, the filter, a beam limiting unit, and a lighting unit. The beam limiting unit is disposed downstream from the source grating in an application direction of the radiation, and defines an irradiation field of the radiation. The lighting unit illuminates the irradiation field of the radiation by projecting light through the beam limiting unit.

The radiation imaging system may further include a first grating, an intensity modulator, and a phase contrast image generator. The first grating is disposed between the source grating and the radiation image detector, and produces a fringe image by passing the radiation therethrough. The intensity modulator applies intensity modulation to the fringe image at plural relative positions having different phases from each other relative to a periodic pattern of the fringe image. The phase contrast image generator generates a phase contrast image of the object. The radiation image detector detects the fringe image modulated by the intensity modulator. The phase contrast image generator generates a phase contrast image of the object based on a plurality of the fringe images obtained by the radiation image detector, from phase information modulated by the object upon passage of the radiation through the object disposed between the source grating and the first grating, or between the first grating and the intensity modulator.

The intensity modulator may include a second grating having a periodic pattern of a same direction as that of the fringe image, and a scan mechanism for shifting one of the first and second gratings at a predetermined pitch.

The first and second gratings may be absorption gratings, and the first grating may project the radiation emitted from the radiation source to the second grating as the fringe image. Alternatively, the first grating may be a phase diffraction grating, and the first grating may project the radiation emitted from the radiation source to the second grating under a Talbot effect as the fringe image.

Each pixel of the radiation image detector may have a conversion layer for converting the radiation into an electric charge and a charge collection electrode for collecting the electric charge converted by the conversion layer. The charge collection electrode may include a plurality of linear electrode groups. The linear electrode groups have a periodic pattern of a same direction as that of the fringe image and are arranged out of phase from each other. The charge collection electrode may compose the intensity modulator.

A collimator unit used in a radiation tube may include a source grating having a plurality of radiation shielding portions and a beam limiting unit. The radiation shielding portions extend in a first direction orthogonal to an optical axis of the radiation and parallel to a rotational axis of the rotating anode, and are arranged at a predetermined pitch along a second direction orthogonal to both of the optical axis and the first direction. The beam limiting unit is disposed downstream from the source grating in an application direction of the radiation, and defines an irradiation field of the radiation.

The collimator unit may further include a filter disposed between the radiation tube and the source grating. In this case, the radiation passes through the source grating after having passed through the filter. The collimator unit may further include a lighting unit for illuminating the irradiation field of the radiation by projecting light through the beam limiting unit.

According to the radiation imaging system and collimator unit of the present invention, since the radiation shielding portions of the source grating extend in parallel with the rotational axis of the rotating anode, the heel effect occurs in parallel with the extending direction of the X-ray shielding portions. Thus, although the intensity of the radiation is reduced by the heel effect in a certain direction, it is possible to prevent further reduction of the intensity of the radiation in the same direction by vignetting. Furthermore, since the filter is disposed upstream from the source grating in the application direction of the radiation, the source grating can form arrayed narrow radiation beams from the radiation disturbed by the filter. This achieves improvement in sharpness of an image, as compared with a conventional case in which the filter is disposed downstream from the source grating. Furthermore, the source grating, the filter, the beam limiting unit, the lighting unit, and the like are integrated into the collimator unit. This improves ease of handling of equipment during radiography.

Disposition of the first grating, the intensity modulator, and the like between the source grating and the radiation image detector allows production of a phase contrast image. Furthermore, the phase contrast image can be produced in various structures of the system, for example, using the second grating and the scan mechanism as the intensity modulator, using the absorption gratings as the first and second gratings, using the phase diffraction grating as the first grating and the Talbot effect, using the radiation image detector having the charge collection electrodes with the periodic pattern, or the like.

### BRIEF DESCRIPTION OF THE DRAWINGS

For more complete understanding of the present invention, and the advantage thereof, reference is now made to the following descriptions taken in conjunction with the accompanying drawings, in which:

FIG. 1 is a schematic view of an X-ray imaging system according to a first embodiment;

FIG. 2 is a block diagram of the X-ray imaging system;

FIG. 3 is a sectional view of an X-ray source;

FIG. 4 is a perspective view showing interior structure of the X-ray source;

FIG. 5 is a schematic view of a flat panel detector;

FIG. 6 is a perspective view of the X-ray imaging system according to the first embodiment;

FIG. 7 is an explanatory view of refraction of an X-ray by presence of an object;

FIG. 8 is an explanatory view of a fringe scan method;

FIG. 9 is a graph showing an example of intensity modulation signals;

FIG. 10 is a schematic view of an X-ray imaging system according to a second embodiment;

FIG. 11 is a schematic view of an X-ray imaging system according to a third embodiment;

FIG. 12 is a perspective view of the X-ray imaging system according to the third embodiment;

FIG. 13 is a schematic view of an X-ray imaging system according to a fourth embodiment;

FIG. 14 is a schematic view of an X-ray imaging system according to a fifth embodiment;

FIG. 15 is a schematic view of an X-ray image detector according to a sixth embodiment;

FIG. 16 is an explanatory view of a heel effect occurring in a rotating anode type X-ray tube, and X-ray intensity distribution affected by the heel effect;

FIG. 17 is an explanatory view of X-ray intensity distribution of the rotating anode type X-ray tube in a direction without occurrence of the heel effect; and

FIG. 18 is an explanatory view of vignetting of X-rays caused by a source grating.

### DESCRIPTION OF THE PREFERRED EMBODIMENTS

### First Embodiment

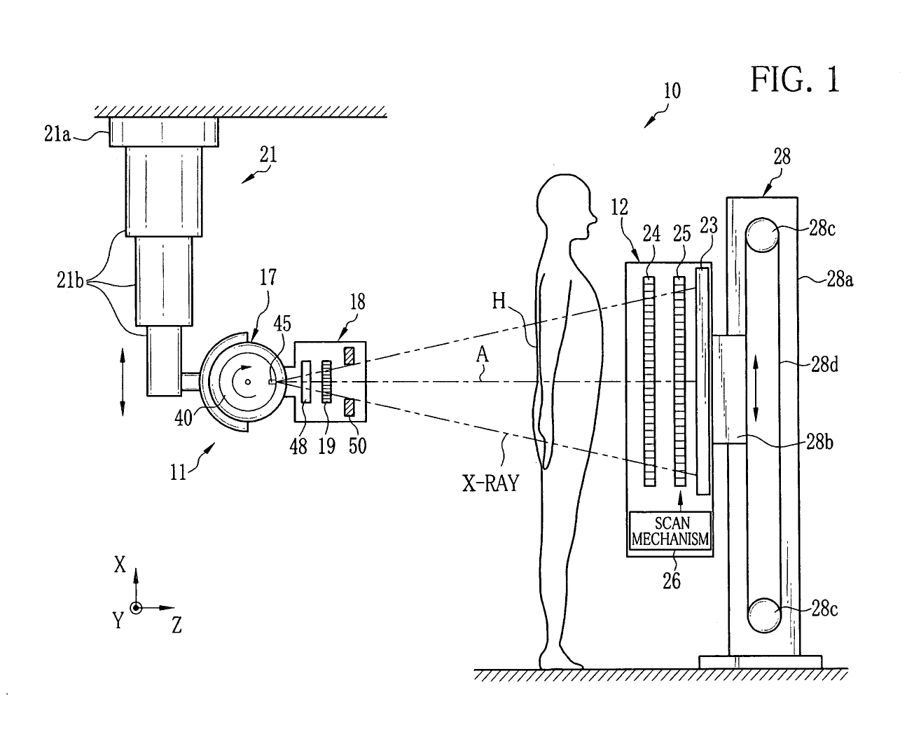

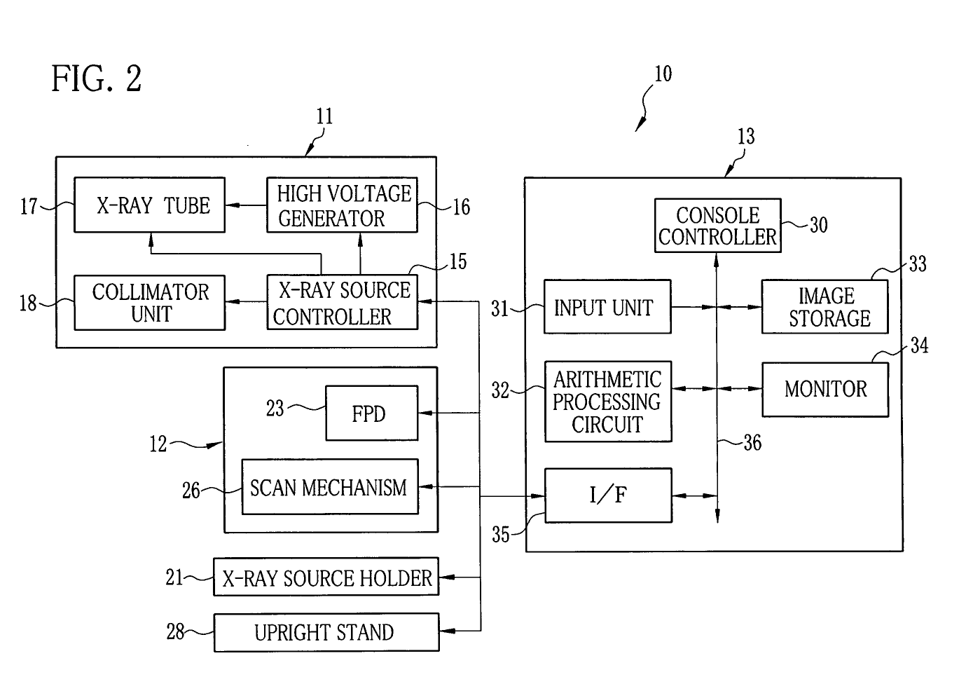

As shown in FIGS. 1 and 2, an X-ray imaging system 10 performs imaging of a standing patient. The X-ray imaging system 10 includes an X-ray source 11, an imaging unit 12, and a console 13. The X-ray source 11 applies X-rays to a body part to be imaged (object) H of the patient. The imaging unit 12 is disposed oppositely to the X-ray source 11, and detects the X-rays that have emitted from the X-ray source 11 and passed through the object H to produce image data. The console 13 controls X-ray application from the X-ray source 11 and imaging operation of the imaging unit 12 in response to operation by an operator. Also, the console 13 applies arithmetic processing to the image data produced by the imaging unit 12, and produces a phase contrast image.

The X-ray source 11 is constituted of an X-ray source controller 15, a high voltage generator 16, an X-ray tube 17, and a collimator unit 18. The X-ray tube 17 emits the X-rays in accordance with a high voltage applied from the high voltage generator 16 under control of the X-ray source controller 15. The collimator unit 18 limits an irradiation field of the X-rays emitted from the X-ray tube 17 so as to block the X-rays out of an image region of interest. The collimator unit 18 includes a source grating 19. The source grating 19 partly blocks the X-rays emitted from the X-ray tube 17 in order to form a group of many narrow line sources.

The X-ray source 11 is held movably in a perpendicular direction (x direction) and a horizontal direction (z direction) by an X-ray source holder 21 hung from a ceiling. The X-ray source holder 21 is composed of a guided vehicle 21a and a plurality of columns 21b coupled in the vertical direction. The guided vehicle 21a is movable in the horizontal direction (z direction) along a rail (not shown) set up on the ceiling. The guided vehicle 21a is provided with a motor (not shown), which extends or retracts the columns 21b to change the position of the X-ray source 11 in the vertical direction.

The imaging unit 12 is provided with a flat panel detector (FPD) 23 composed of a semiconductor circuit, a first absorption grating 24, a second absorption grating 25, and a scan mechanism 26. The first and second absorption gratings 24 and 25 are used for detecting phase shift of an X-ray wavefront caused by the object H, and performing phase contrast imaging. The FPD 23 is disposed such that its detection surface is orthogonal to an optical axis A of the X-rays emitted from the X-ray source 11. The first and second absorption gratings 24 and 25 are disposed between the FPD 23 and the X-ray source 11, though details will be described later on. The scan mechanism 26 translationally moves the second absorption grating 25 in a direction perpendicular to a grating direction, in order to change the position of the second absorption grating 25 relative to the first absorption grating 24. The scan mechanism 26 is composed of an actuator such as, for example, a piezoelectric element. The second absorption grating 25 and the scan mechanism 26 compose an intensity modulator. Instead of the second absorption grating 25, the first absorption grating 24 may be moved.

The imaging unit 12 is held movably in the vertical direction by an upright stand 28 set up on a floor. The upright stand 28 has a main body 28a erected on the floor and a holder 28b for holding the imaging unit 12. The holder 28b is attached to the main body 28a movably in the vertical direction. The holder 28b is connected to an endless belt 28d, which is looped over two pulleys 28c disposed away from each other in the vertical direction, and is driven by a motor (not shown) for rotating the pulley 28c. The drive of the motor is controlled by a console controller 30 of the console 13, described later on, in response to setting operation of the operator. Note that, the imaging unit 12 may be held by a hanging type holder hung from the ceiling, as with the X-ray source 11.

The upright stand 28 is provided with a position sensor (not shown) such as a potentiometer, which measures a conveyance distance of the pulley 28c or the endless belt 28d to detect the vertical position of the imaging unit 12. A detection value of the position sensor is supplied to the X-ray source holder 21 via a cable or the like. The X-ray source holder 21 extends or retracts the columns 21b based on the supplied detection value, and lifts down or up the X-ray source 11 so as to follow vertical movement of the imaging unit 12.

The console 13 is provided with the console controller 30 having a CPU, a ROM, a RAM, and the like. To the console controller 30, an input unit 31 for inputting an imaging command and the contents of the command, an arithmetic processing circuit 32 for producing an X-ray image from the image data obtained by the imaging unit 12, an image storage 33 for storing the X-ray image, a monitor 34 for displaying the X-ray image and the like, and an interface (I/F) 35 are connected through a bus 36. The I/F 35 is connected to each part of the X-ray imaging system 10.

As the input unit 31, for example, a switch, a touch panel, a mouse, a keyboard, and the like are usable. By operation on the input unit 31, X-ray imaging conditions including an X-ray tube voltage and an X-ray exposure time, imaging timing, and the like are inputted. The monitor 34 consists of a liquid crystal display or the like. The monitor 34 displays text of the X-ray imaging conditions, the X-ray image, and the like under control of the console controller 30.

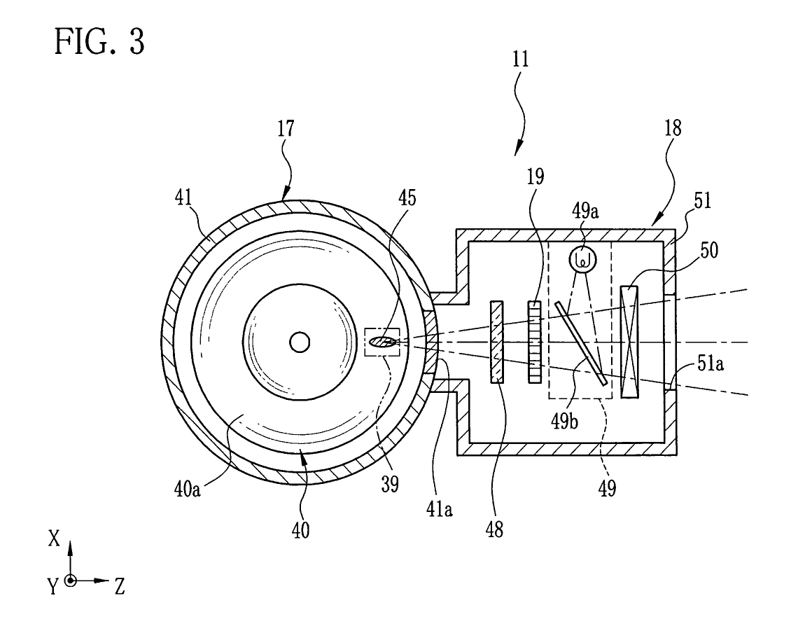

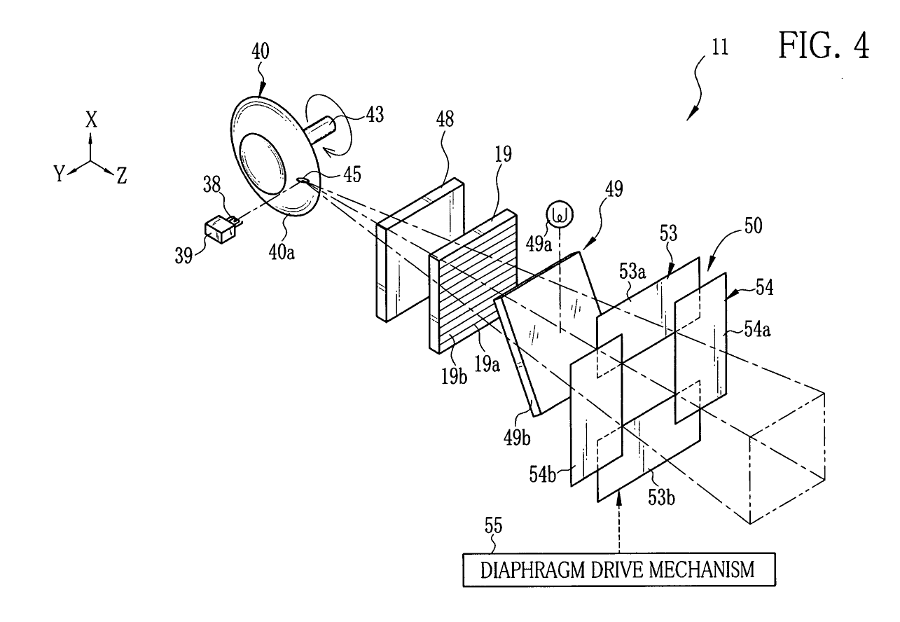

Next, the X-ray source 11 will be described. As shown in FIGS. 3 and 4, the X-ray tube 17 is provided with a cathode 39 having a filament 38 for emitting thermoelectrons as an electron beam, and a rotating anode (target) 40 for emitting the X-rays upon application of the electron beam. The filament 38 and the rotating anode 40 are contained in a tube bulb 41 maintained under vacuum of the order of 10⁻⁷ mmHg.

The cathode 39 is fixed in a predetermined position inside the tube bulb 41. A rotational axis 43 is connected at the center of the rotating anode 40. The rotational axis 43 is rotatably supported by a bearing (not shown) provided on the tube bulb 41. The rotational axis 43 composes an induction motor together with a coil provided around the rotational axis 43 through the tube bulb 41. The rotational axis 43 rotates by passage of an electric current through the coil.

The rotating anode 40 is made of metal (tungsten, a tungsten alloy, or the like) into an approximately disk shape. In the rim of the rotating anode 40, a target surface 40a inclined at a predetermined angle is formed. The high voltage generator 16 applies a high voltage between the cathode 39 and the rotating anode 40. To the cathode 39, a heating current is applied from a filament heating circuit (not shown) to heat the filament 38.

The heated filament 38 emits the thermoelectrons. The thermoelectrons are accelerated by the high voltage applied by the high voltage generator 16. The accelerated thermoelectrons become the electron beam, and collide against the target surface 40a of the rotating anode 40. Upon collision of the electron beam, the X-rays are emitted from an X-ray focus 45 formed on the target surface 40a. The cone-beam X-rays radiating from the X-ray focus 45 pass through an X-ray outlet 41a provided in a part of the tube bulb, and are applied to the object H through the collimator unit 18.

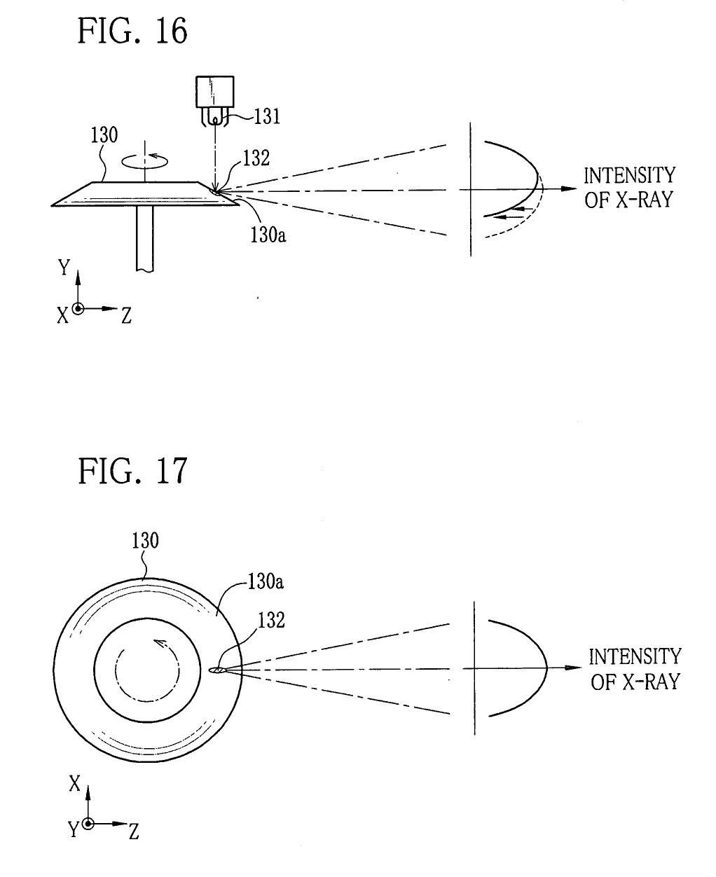

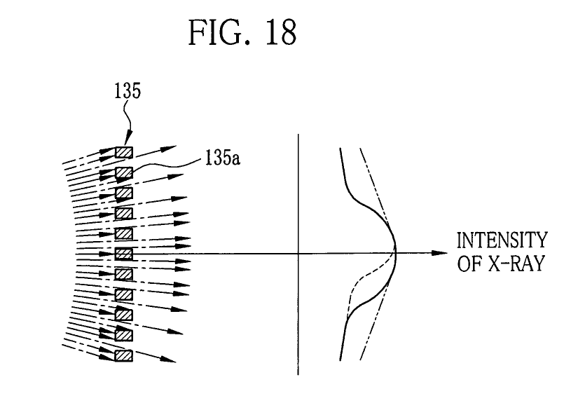

The heel effect occurs in the intensity of the X-rays radiating from the X-ray focus 45, as in the case of the rotating anode 130 shown in FIGS. 16 and 17. Thus, the intensity of the X-rays is gradually reduced with approaching a tangential direction of the target surface 40a.

The collimator unit 18 is constituted of a filter set 48 including one or more filter elements, the source grating 19 described above, a beam limiting unit 50, a lighting unit 49, and a case 51. The case 51 contains the filter set 48, the source grating 19, the beam limiting unit 50, and the lighting unit 49, and is held by the tube bulb 41. The filter set 48 regulates a spectrum of the X-rays emitted from the X-ray tube 17, by taking advantage of difference in an X-ray attenuation coefficient of the filter element on a wavelength. The beam limiting unit 50 limits the irradiation field or distribution of the X-rays in a plane orthogonal to the optical axis of the X-rays at a predetermined distance away from a focal spot. The lighting unit 49 illuminates the irradiation field or distribution of the X-rays. The case 51 has an opening 51a through which the X-rays are applied to the object H.

The filter set 48 has a size, in a position where the filter set 48 is disposed, enough to receive all the X-rays in a plane orthogonal to the optical axis of the X-rays. The filter set 48 is made of, for example, Al, Cu, Mo, Rh or a combination of two or more of these materials, and has a thickness of 0.01 to 1 mm.

The source grating 19 has a plurality of X-ray shielding portions 19a and X-ray transmitting portions 19b, which extend in one direction (hereinafter called y direction) in a plane orthogonal to the z direction, and are alternately arranged at a predetermined pitch in a direction (hereinafter called x direction) orthogonal both the z and y directions. The source grating 19 preferably has a size, in a position where the source grating 19 is disposed, larger than an area of X-ray distribution centered on the optical axis of the X-rays. The X-ray shielding portions 19a are preferably made of metal having high X-ray absorptivity, such as Au, Pt, Ni, W, or Mo, for example. The X-ray transmitting portions 19b are preferably made of a low X-ray absorption material while maintaining the shape of the X-ray shielding portions 19a, such as an X-ray transparent high polymer or light material, for example, photoresist or Si.

The lighting unit 49 is provided with a lamp 49a for emitting visible light, and a mirror 49b for reflecting the light from the lamp 49a to the opening 51a of the case 51. The lamp 49a and the mirror 49b are disposed so as to apply the visible light having the same irradiation field as that of the X-rays through the opening 51a. Thus, the operator can check the irradiation field of the X-rays at the sight of the visible light applied to the object H or the imaging unit 12. Since the lighting unit 49 is disposed so as not to shade the X-rays, the lighting unit 49 does not cause attenuation of the X-rays. The mirror 49b preferably has high X-ray transparency.

The beam limiting unit 50 has a first diaphragm pair 53 for changing the distribution of the X-rays in the x direction in a plane orthogonal to the optical axis of the X-rays, and a second diaphragm pair 54 for changing the distribution of the X-rays in the y direction in the same plane. The first diaphragm pair 53 including a pair of diaphragms 53a and 53b movable in the x direction and the second diaphragm pair 54 including a pair of diaphragms 54a and 54b movable in the y direction compose so-called double leaf structure. The diaphragms 53a, 53b, 54a, and 54b are moved by a diaphragm drive mechanism 55, and define the irradiation field of the X-rays. The diaphragms 53a, 53b, 54a, and 54b are made of lead or the like having high X-ray absorptivity.

The X-rays emitted from the X-ray tube 17 are applied to the object H through the filter set 48, the source grating 19, the lighting unit 49, and the beam limiting unit 50. Since the filter set 48 is disposed upstream from the source grating 19 in an application direction of the X-rays, the source grating 19 can form arrayed narrow focuses of X-ray beams from the X-rays disturbed by the filter element. The X-ray shielding portions 19a and the X-ray transmitting portions 19b of the source grating 19 extend in parallel with the rotational axis 43 of the rotating anode 40. Thus, the heel effect occurs in parallel with the extending direction of the X-ray shielding portions 19a and the X-ray transmitting portions 19b. Furthermore, the filter set 48, the source grating 19, the lighting unit 49, and the beam limiting unit 50 are integrally contained in the case 51, to improve ease of handling as the collimator unit 18.

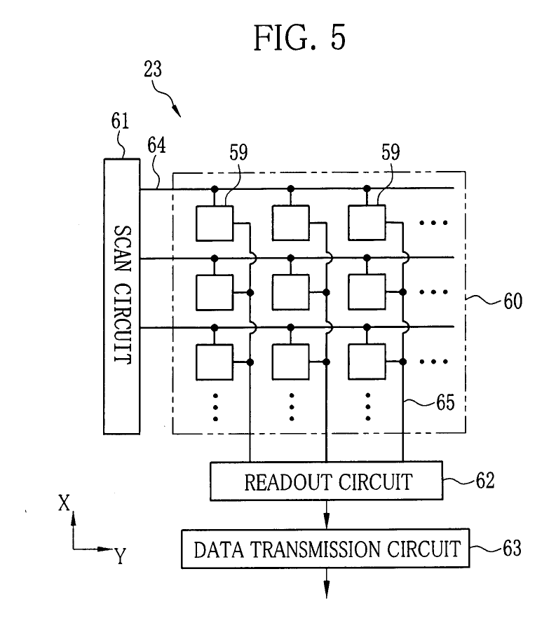

As shown in FIG. 5, the FPD 23 is constituted of an imaging section 60, a scan circuit 61, a readout circuit 62, and a data transmission circuit 63. In the imaging section 60, a plurality of pixels 59 for converting the X-rays into electric charges and accumulating the electric charges are arrayed on an active matrix substrate in two dimensions along the x and y directions. The scan circuit 61 controls readout timing of the electric charges from the imaging section 60. The readout circuit 62 reads out the electric charges from individual pixels 59, and converts the electric charges into image data, and stores the image data. The data transmission circuit 63 transmits the image data to the arithmetic processing circuit 32 of the console 13 through the I/F 35. Every pixel 59 is connected to the scan circuit 61 on a line-by-line basis by a scan line 64. Every pixel 59 is also connected to the readout circuit 62 on a column-by-column basis by a signal line 65.

The pixel 59 is a direct conversion type X-ray detector, in which the X-rays are directly converted into the electric charge by a conversion layer (not shown) of amorphous selenium or the like, and the converted electric charge is accumulated in a capacitor (not shown) connected to an electrode below the conversion layer. To each pixel 59, a TFT switch (not shown) is connected. More specifically, a gate electrode of the TFT switch is connected to the scan line 64, and a source electrode thereof is connected to the capacitor, and a drain electrode thereof is connected to the signal line 65. When a drive pulse from the scan circuit 61 turns on the TFT switch, the electric charge accumulated in the capacitor is read out to the signal line 65.

The pixel 59 may be an indirect conversion type X-ray detector, in which the X-rays are once converted into visible light by a scintillator (not shown) of terbium-activated gadolinium oxysulfide (Gd₂O₂S:Tb), thallium-activated cesium iodide (CsI:Tl), or the like, and the converted visible light is converted into the electric charge by a photodiode (not shown). In this embodiment, the FPD based on a TFT panel is used as a radiation image detector, but various types of radiation image detectors based on a solid-state image sensor such as a CCD or CMOS image sensor may be used instead.

The readout circuit 62 includes an integration amplifier, an A/D converter, a correction circuit, and an image memory (none of above is shown). The integration amplifier integrates the electric charges outputted from the pixels 59 through the signal lines 65, and converts the electric charges into a voltage signal (image signal), and inputs the image signal to the A/D converter. The A/D converter converts the inputted image signal into digital image data, and inputs the digital image data to the correction circuit. The correction circuit applies an offset correction, a gain correction, and a linearity correction to the image data, and writes the corrected image data to the image memory. The correction circuit may carry out a correction of an X-ray exposure amount and exposure distribution (so-called shading correction), a correction of pattern noise (for example, a leak signal of the TFT switch) according to control conditions (a drive frequency and a readout period) of the FPD 23, and the like.

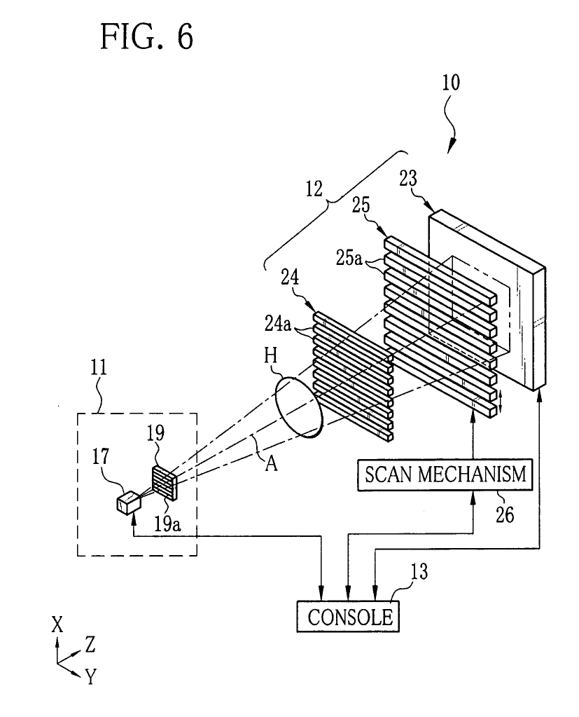

Similarly to the source grating 19, as shown in FIG. 6, the first absorption grating 24 has a plurality of X-ray shielding portions 24a and X-ray transmitting portions 24b, which extend in the y direction and are alternately arranged at a predetermined pitch in the x direction. Likewise, the second absorption grating 25 has a plurality of X-ray shielding portions 25a and X-ray transmitting portions 25b, which extend in the y direction and are alternately arranged at a predetermined pitch in the x direction. As with the source grating 19, the X-ray shielding portions 24a and 25a are preferably made of Au, Pt, Ni, W, Mo, or the like, and the X-ray transmitting portions 24b and 25b are preferably made of Si or the like.

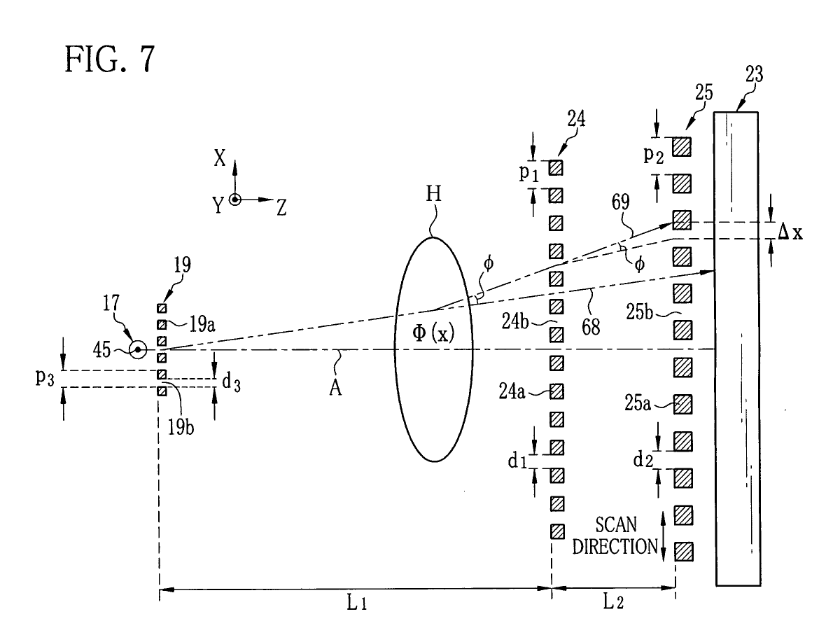

Referring to FIG. 7, the X-ray shielding portions 24a of the first absorption grating 24 are arranged in the x direction at a predetermined grating pitch p₁ and at a predetermined spacing distance d₁ apart from one another. The X-ray shielding portions 25a of the second absorption grating 25 are arranged in the x direction at a predetermined grating pitch p₂ and at a predetermined spacing distance d₂ apart from one another. Similarly, the X-ray shielding portions 19a of the source grating 19 are arranged in the x direction at a predetermined grating pitch p₃ and at a predetermined spacing distance d₃ apart from one another. The X-ray shielding portions 19a, 24a, or 25a are arranged on an X-ray transparent substrate (for example, a glass substrate; not shown). The first and second absorption gratings 24 and 25 and the source grating 19 do not give phase difference to the incident X-rays, but give intensity difference. Thus, the gratings 19, 24, and 25 are referred to as amplitude gratings. The X-ray transmitting portions 19b, 24b, and 25b are empty slits in FIG. 7, but may be filled with a low X-ray absorption material such as a high polymer or light metal.

Irrespective of the presence or absence of the Talbot effect, the first and second absorption gratings 24 and 25 are designed so as to geometrically project the X-rays passed through the X-ray transmitting portions 24b and 25b. To be more specific, the spacing distances d₁ and d₂ are set sufficiently larger than a peak wavelength of the X-rays emitted from the X-ray source 11. Thus, the almost all incident X-rays are not diffracted by the X-ray transmitting portions 24b and 25b, but pass therethrough straight ahead. In a case where tungsten is used in the rotating anode 40 of the X-ray tube 17 and the tube voltage is 50 kV, for example, the peak wavelength of the X-rays is approximately 0.4 Å. In this case, if the spacing distances d₁ and d₂ are set at the order of 1 to 10 μm, the almost all X-rays are geometrically projected through the slits without diffraction. In this case, the grating pitches p₁ and p₂ are set at the order of 2 to 20 μm.

The X-rays emitted from the X-ray source 11 are not form a parallel beam, but form a cone beam radially diverging from the X-ray focus 45. Thus, a projective image (hereinafter called G1 image or fringe image) projected through the first absorption grating 24 is magnified in proportion to a distance from the source grating 19, being a substantial X-ray focus. The grating pitch p₂ and spacing distance d₂ of the second absorption grating 25 are designed such that its X-ray transmitting portions 25b substantially coincide with a periodic pattern of bright portions of the G1 image formed in the position of the second grating 25. In other words, the grating pitch p₂ and spacing distance d₂ of the second absorption grating 25 satisfy the following expressions (1) and (2):

$$\begin{matrix}{p}_{2} = \frac{{L}_{1} + {L}_{2}}{{L}_{1}} {p}_{1} & ( 1 ) \\ {d}_{2} = \frac{{L}_{1} + {L}_{2}}{{L}_{1}} {d}_{1} & ( 2 )\end{matrix}$$

Wherein, L₁ represents a distance from the source grating 19 to the first absorption grating 24, and L₂ represents a distance from the first absorption grating 24 to the second absorption grating 25.

The grating pitch p₃ of the source grating 19 satisfies the following expression (3):

$${p}_{3} = \frac{{L}_{1}}{{L}_{2}} {p}_{2} \qquad ( 3 )$$

In the case of a Talbot interferometer, the length L₂ between the first and second absorption gratings 24 and 25 is restricted to a Talbot distance, which depends on a grating pitch of a first diffraction grating and the wavelength of X-rays. According to the imaging unit 12 of this embodiment, however, since the incident X-rays are projected through the first absorption grating 24 without diffraction, the G1 image of the first absorption grating 24 is observable in any position behind the first absorption grating 24 in a geometrically similar manner. Thus, the length L₂ can be set independently of the Talbot distance.

Although the imaging unit 12 according to this embodiment does not compose the Talbot interferometer, as described above, a Talbot distance Zₘ is represented by the following expression (4), on the assumption that the first absorption grating 24 would diffract the X-rays and produce the Talbot effect:

$${Z}_{m} = m \frac{{p}_{1} {p}_{2}}{λ} \qquad ( 4 )$$

Wherein, p₁ represents the grating pitch of the first absorption grating 24, and p₂ represents the grating pitch of the second absorption grating 25. λ represents the wavelength of the X-rays (peak wavelength). m represents a positive integer.

In this embodiment, since the length L₂ can be set independently of the Talbot distance, as described above, the length L₂ is set shorter than the minimum Talbot distance Z₁ defined at m=1, for the purpose of downsizing the imaging unit 12 in the z direction. In other words, the length L₂ is within the confines of the following expression (5):

$${L}_{2} < \frac{{p}_{1} {p}_{2}}{λ} \qquad ( 5 )$$

To produce a periodic pattern image with high contrast, it is preferable that the X-ray shielding portions 19a, 24a, and 25a completely block (absorb) the X-rays. However, some X-rays pass through the X-ray shielding portions 19a, 24a, and 25a without being absorbed, even with the use of the above material having high X-ray absorptivity (Au, Pt, Ni, W, Mo, or the like). For this reason, it is preferable to thicken each of the X-ray shielding portions 19a, 24a, and 25a in the z direction as much as possible. In a sense, it implies to increase an aspect ratio of each shielding portion 19a, 24a, or 25a, to improve an X-ray shielding property. For example, when the X-ray tube voltage is 50 kV, the percentage of the incident X-rays to be blocked is preferably 90% or more. In this case, the X-ray shielding portion 19a, 24a, or 25a preferably has a thickness of 30 μm or more of a gold (Au) equivalent.

Using the first and second absorption gratings 24 and 25 having above structure, the FPD 23 captures a fringe image that is subjected to intensity modulation by superimposing the second absorption grating 25 on the G1 image (fringe image) of the first absorption grating 24. A pattern period of the G1 image in the position of the second absorption grating 25 slightly deviates from the grating pitch p₂ of the second absorption grating 25 due to a manufacturing error and an alignment error. This slight deviation causes occurrence of moiré fringes in the fringe image subjected to the intensity modulation. If the grating directions of the first and second absorption gratings 24 and 25 deviate from each other, so-called rotational moiré fringes appear. However, the moiré fringes appearing in the fringe image do not cause a problem, if a period of the moiré fringes in the x or y direction is larger than an arrangement pitch of the pixel 59. Ideally, it is preferable that the moiré fringes do not appear, but the moiré fringes are usable for checking a scanning amount (translationally moved distance of the second absorption grating 25) in fringe scanning.

If the object H is disposed between the X-ray source 11 and the first absorption grating 24, the fringe image detected by the FPD 23 is modulated by the object H. This modulation amount is proportionate to a deviation angle of the X-rays due to refraction by the object H. Consequently, analysis of the fringe image detected by the FPD 23 allows production of the phase contrast image of the object H.

Next, a method for analyzing the fringe image will be described. FIG. 7 shows an example of the X-ray that is refracted according to phase shift distribution Φ(x) with respect to the x direction of the object H. A reference numeral 68 indicates a path of the X-ray that travels straight ahead in the absence of the object H. The X-ray traveling in this path 68 passes through the first and second absorption gratings 24 and 25, and is incident upon the FPD 23. A reference numeral 69, on the other hand, indicates a path of the X-ray that is refracted by the object H in the presence of the object H. The X-ray traveling in this path 69 passes through the first absorption grating 24, and then is blocked by the X-ray shielding portion 25a of the second absorption grating 25.

The phase shift distribution Φ(x) of the object H is represented by the following expression (6), using refractive index distribution n(x, z) of the object H:

$$Φ ( x ) = \frac{2 π}{λ} \int [ 1 - n ( x , z ) ] d z \qquad ( 6 )$$

Wherein, the X-ray travels in the z direction.

The G1 image projected from the first absorption grating 24 to the position of the second absorption grating 25 is displaced in the x direction by an amount corresponding to a refraction angle φ due to the refraction of the X-ray by the object H. This displacement Δx is approximately represented by the following expression (7), on condition that the refraction angle φ of the X-ray is sufficiently small:

Δx≈L₂φ (7)

The refraction angle φ is represented by the following expression (8), using the wavelength λ of the X-ray and the phase shift distribution Φ(x) of the object H:

$$φ = \frac{λ}{2 π} \frac{\partial Φ ( x )}{\partial x} \qquad ( 8 )$$

As is obvious from the above expressions, the displacement Δx of the G1 image due to the refraction of the X-ray by the object H relates to the phase shift distribution Φ(x) of the object H. Furthermore, the displacement Δx relates to a phase shift ψ of an intensity modulation signal of each pixel 59 detected by the FPD 23 (shift in a phase of the intensity modulation signal of each pixel 59 between in the presence and absence of the object H), as is represented by the following expression (9):

$$ψ = \frac{2 π {L}_{2}}{{p}_{2}} φ = \frac{2 π}{{p}_{2}} Δ x \qquad ( 9 )$$

Thus, determination of the phase shift ψ of the intensity modulation signal of each pixel 59 leads to obtainment of the refraction angle φ using the expression (9), and furthermore leads to obtainment of the differentiation of the phase shift distribution Φ(x) using the expression (8). Integrating the differentiation with respect to x allows obtainment of the phase shift distribution Φ(x) of the object H, in other words, production of the phase contrast image of the object H. In this embodiment, the above phase shift ψ is determined by the following fringe scanning technique.

In the fringe scanning technique, the images are captured, while one of the first and second absorption gratings 24 and 25 is translationally moved in the x direction relative to the other, in other words, while changing a phase between grating periods of the first and second absorption gratings 24 and 25. In this embodiment, the scan mechanism 26 moves the second absorption grating 25. With the movement of the second absorption grating 25, the moiré fringes move. When a moved distance along the x direction reaches the single grating period (grating pitch p₂) of the second absorption grating 25, in other words, when the phase change reaches 2π, the moiré fringes return to the original positions. The FPD 23 captures the fringe images, whenever the second absorption grating 25 is moved at a scan pitch of an integral submultiple of the grating pitch p₂. Then, the intensity modulation signal of each pixel 59 is obtained from the captured plural fringe images. The arithmetic processing circuit 32 applies arithmetic processing to the intensity modulation signal, to obtain the phase shift ψ of the intensity modulation signal of each pixel 59. The two-dimensional distribution of the phase shift ψ corresponds to a differential phase image.

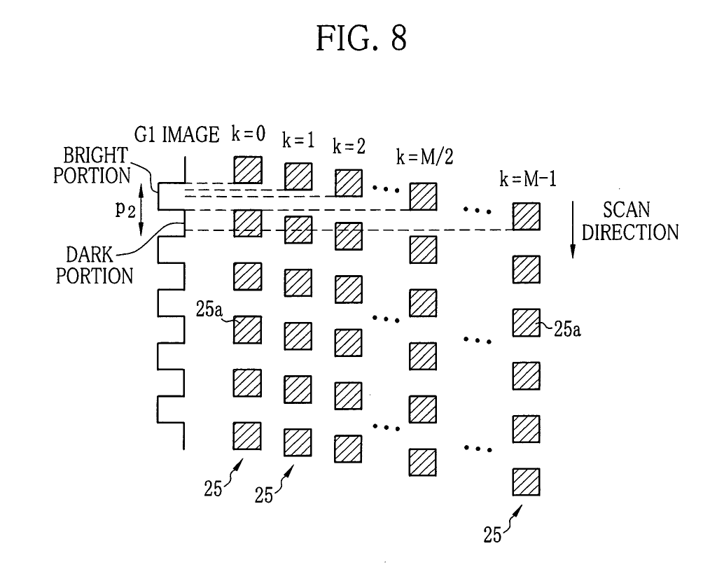

FIG. 8 schematically shows a state of moving the second absorption grating 25 by a scan pitch of p₂/M, in which the grating pitch p₂ is divided by M (integer of 2 or more). The scan mechanism 26 translationally moves the second absorption grating 25 to each of an M number of scan positions represented by k=0, 1, 2, . . . , M−1. According to FIG. 8, an initial position of the second absorption grating 25 is defined at a position (k=0) where the X-ray shielding portions 25a substantially coincide with dark portions of the G1 image formed in the position of the second absorption grating 25 in the absence of the object H. However, the initial position may be defined at any position out of k=0, 1, 2, . . . M−1.

In the position of k=0, a non-refracted X-ray component and a part of a refracted X-ray component substantially pass through the second absorption grating 25. The non-refracted X-ray component consists of the X-rays that have not been refracted by the object H. The refracted X-ray component consists of the X-rays that have been refracted by the object H, and passed through the first absorption grating 24. When the second absorption grating 25 is successively moved to k=1, 2, . . . , the percentage of the non-refracted X-ray component is decreased, while the percentage of the refracted X-ray component is increased, in the X-rays detected through the second absorption grating 25. Especially, in the position of k=M/2, substantially only the refracted X-ray component passes through the second absorption grating 25. After the position of k=M/2, on the contrary, the percentage of the refracted X-ray component is decreased, while the percentage of the non-refracted X-ray component is increased, in the X-rays detected through the second absorption grating 25.

Since the FPD 23 captures an image in each of the positions of k=0, 1, 2, . . . , M−1, an M number of pixel data is obtained on each pixel 59. A method for calculating the phase shift ψ of the intensity modulation signal of each pixel 59 from the M number of pixel data will be hereinafter described. When the second absorption grating 25 is in the position k, the pixel data Iₖ(x) of each pixel 59 is represented by the following expression (10):

$${I}_{k} ( x ) = {A}_{0} + {\sum }_{n > 0} {A}_{n} exp [ 2 πi \frac{n}{{p}_{2}} \{ {L}_{2} φ ( x ) + \frac{{kp}_{2}}{M} \} ] \qquad ( 10 )$$

Wherein, “x” represents a coordinate of the pixel 59 in the x direction. “A₀” represents the intensity of the incident X-rays. “Aₙ” represents a value corresponding to contrast of the intensity modulation signal. “n” is a positive integer. “φ(x)” represents the above refraction angle φ as a function of the coordinate x.

Using the following expression (11), the refraction angle φ(x) is represented by the following expression (12):

$$\begin{matrix}{\sum }_{k = 0}^{M - 1} exp ( - 2 πi \frac{k}{M} ) = 0 & ( 11 ) \\ φ ( x ) = \frac{{p}_{2}}{2 π {L}_{2}} arg [ {\sum }_{k = 0}^{M - 1} {I}_{k} ( x ) exp ( - 2 πi \frac{k}{M} ) ] & ( 12 )\end{matrix}$$

Wherein, “arg[ ]” means extraction of the argument, and corresponds to the phase shift ψ. Therefore, the determination of the phase shift ψ based on the expression (12) from the M number of pixel data (intensity modulation signals) obtained from each pixel 59 allows obtainment of the refraction angle φ(x) and the differentiation of the phase shift distribution Φ(x).

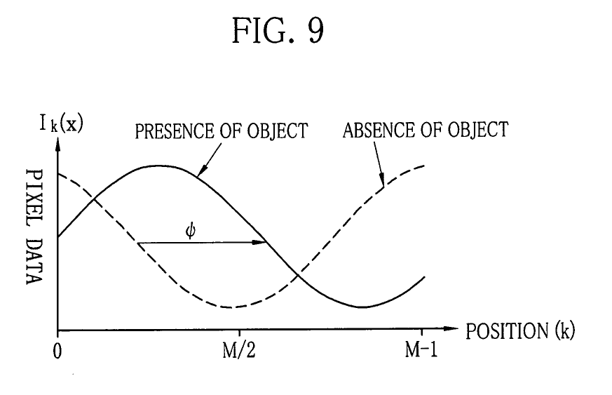

To be more specific, taking the position k of the second absorption grating 25 in a horizontal axis, the M number of pixel data obtained from each pixel 59 is plotted on a graph and fits a sine wave. Thus, as shown in FIG. 9, the intensity modulation signal, which varies with a period of the grating pitch P₂, is obtained. In FIG. 9, a dashed line represents the intensity modulation signal in the absence of the object H, and a solid line represents the intensity modulation signal in the presence of the object H. The phase difference between waveforms of the intensity modulation signals corresponds to the above phase shift ψ.

Although a Y coordinate of each pixel 59 is not considered in the above description, carrying out similar calculations with respect to each Y coordinate allows obtainment of two-dimensional distribution ψ(x, y) of the phase shift over the X and Y directions. This two-dimensional distribution ψ(x, y) of the phase shift corresponds to the differential phase image.

The differential phase image is inputted to the arithmetic processing circuit 32. The arithmetic processing circuit 32 integrates the inputted differential phase image along the x axis, to produce the phase shift distribution Φ(x, y) of the object H. The phase shift distribution Φ(x, y) is written to the image storage 33 as the phase contrast image.

Next, operation of this embodiment will be described. In the X-ray imaging system 10, the operator inputs the imaging command from the console 13 in a state where the object H is disposed between the X-ray source 11 and the imaging unit 12. In response to the imaging command, the console controller 30 actuates each part of the X-ray imaging system 10 such that the X-ray source 11 applies the X-rays to the object H and the FPD 23 detects the X-ray image in each scan position, while the second absorption grating 25 is moved relative to the first absorption grating 24.

In the X-ray source 11, the electron beam is emitted from the cathode 39 to the rotating anode 40, and the X-rays are emitted from the X-ray focus 45 of the target surface 40a during the X-ray exposure time. The X-rays emitted from the X-ray focus 45 are applied to the object H through the filter set 48, the source grating 19, the lighting unit 49, and the beam limiting unit 50.

As in the case of the rotating anode 130 shown in FIGS. 16 and 17, the heel effect occurs in the X-rays emitted from the X-ray focus 45. In this embodiment, however, source grating 19 is laid out such that the X-ray shielding portions 19a and the X-ray transmitting portions 19b extend in parallel with the rotational axis 43 of the rotating anode 40. Therefore, the heel effect occurs in a direction parallel to the extending direction of the X-ray shielding portions 19a and the X-ray transmitting portions 19b. Although the intensity of the X-rays is reduced by the heel effect in a certain direction, the above layout prevents further reduction of the intensity of the X-rays in the same direction by vignetting. Furthermore, since the filter set 48 is disposed upstream from the source grating 19 in the application direction of the X-rays, the source grating 19 can form the arrayed narrow focuses of the X-ray beams from the X-rays disturbed by the filter element. This achieves improvement in the sharpness of the X-ray image, as compared with a conventional case in which the filter set is disposed downstream from the source grating.

### Second Embodiment

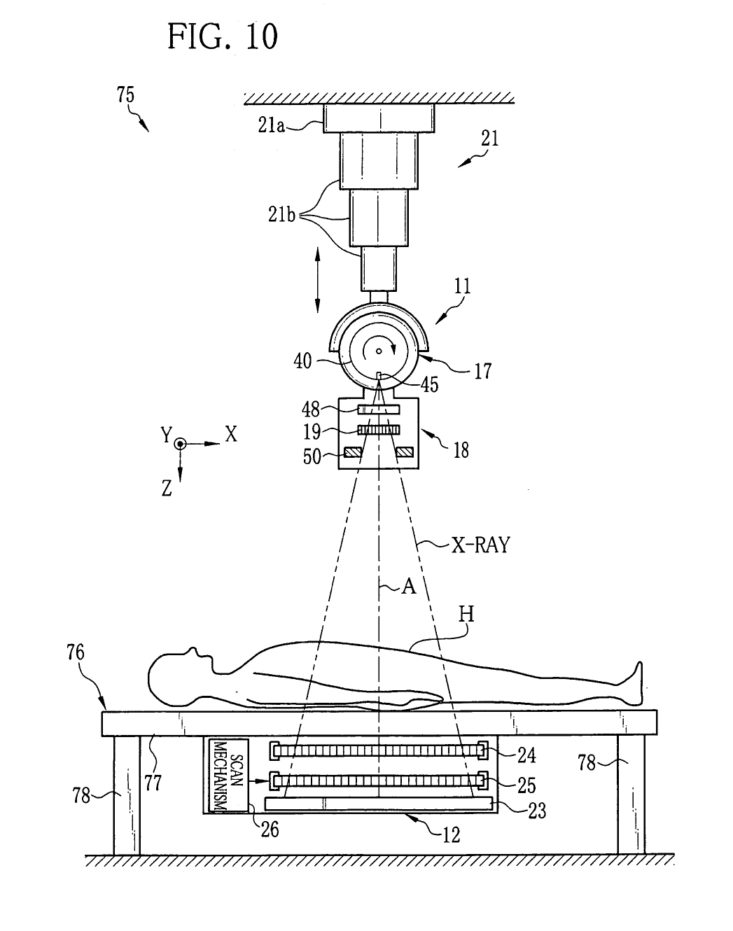

FIG. 10 shows an X-ray imaging system 75 according to a second embodiment of the present invention. The X-ray imaging system 75 has a bed 76 for laying the patient, and takes an X-ray image of the lying patient. Since the X-ray source 11 and the imaging unit 12 have the same structure as those of the first embodiment, each component thereof is designated by the same reference numeral as that of the first embodiment. Only difference from the first embodiment will be described. The other structure and operation are the same as those of the first embodiment, and detailed description thereof will be omitted.

In this embodiment, the imaging unit 12 is attached to a bottom surface of a top table 77 so as to face the X-ray source 11 across a body part to be imaged (object) H of the patient. The X-ray source 11 is held by the X-ray source holder 21, and an angle changing mechanism (not shown) of the X-ray source 11 aims the X-ray application direction downward. In this state, the X-ray source 11 applies the X-rays to the object H of the patient lying on the top table 77 of the bed 76. The X-ray source holder 21 can move up or down the X-ray source 11 by extending or retracting the columns 21b. This movement facilitates adjustment of a distance between the X-ray focus and the detection surface of the FPD 23.

As described above, the imaging unit 12 can be slimmed, because the distance L₂ between the first and second absorption gratings 24 and 25 can be shortened. The slim imaging unit 12 allows the bed 76 to have short legs 78 and to lower the position of the top table 77. For example, the position of the top table 77 is preferably at a height (for example, approximately 40 cm from the floor) that the patient sits thereon with ease. The low top table 77 is also preferable in terms of securing the sufficient distance between the X-ray source 11 and the imaging unit 12.

Oppositely to the above positional relation between the X-ray source 11 and the imaging unit 12, the X-ray source 11 may be attached to the bed 76 and the imaging unit 12 may be set on the side of the ceiling, to take the X-ray image of the lying patient.

### Third Embodiment

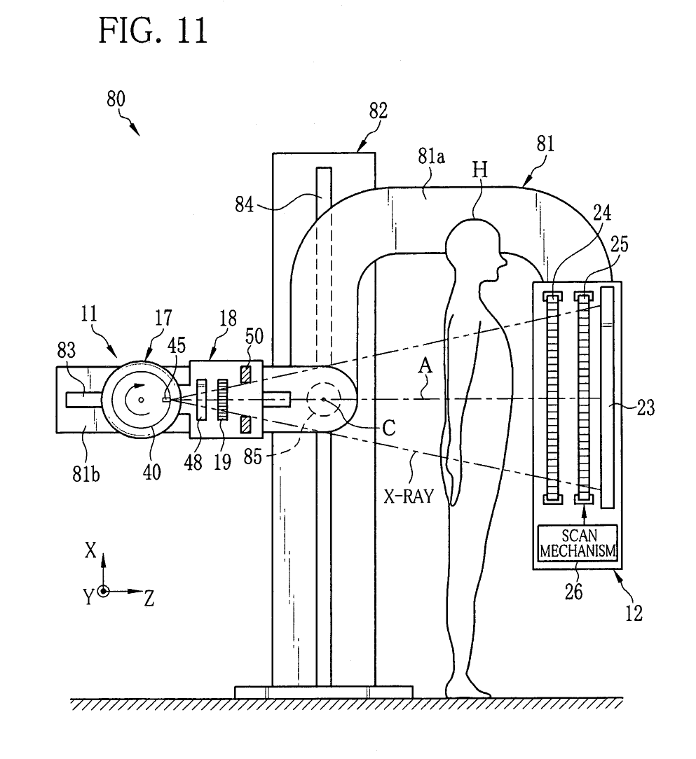

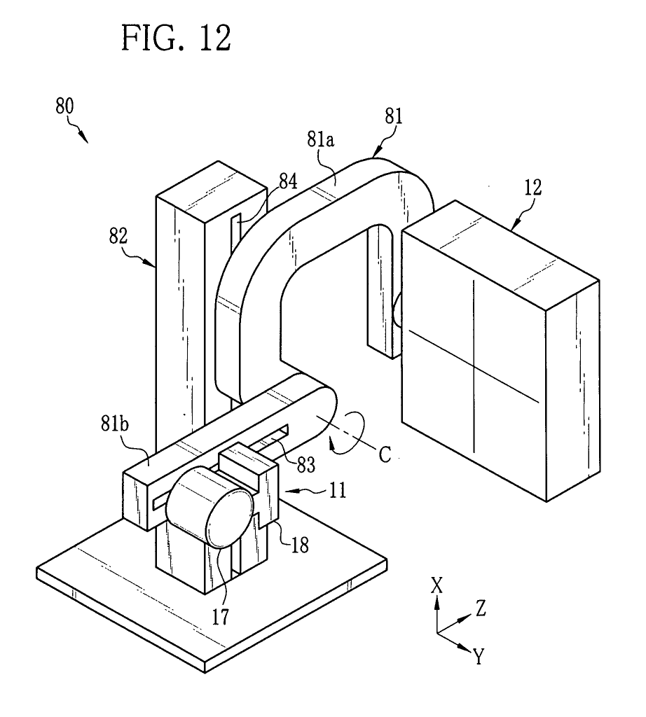

FIGS. 11 and 12 show an X-ray imaging system 80 according to a third embodiment of the present invention. The X-ray imaging system 80 takes an X-ray image of the standing or lying patient. In the X-ray imaging system 80, the X-ray source 11 and the imaging unit 12 are held by a swing arm 81. The swing arm 81 is coupled to a base 82 in a swingable manner. Since the X-ray source 11 and the imaging unit 12 have the same structure as those of the first embodiment, each component thereof is designated by the same reference numeral as that of the first embodiment. Only difference from the first embodiment will be described. The other structure and operation are the same as those of the first embodiment, and detailed description thereof will be omitted.

The swing arm 81 is constituted of a′ U-shaped member 81a and a linear member 81b connected to one end of the U-shaped member 81a. The imaging unit 12 is attached to the other end of the U-shaped member 81a. In the linear member 81b, a first groove 83 is formed along its longitudinal direction. The X-ray source 11 is slidably attached to the first groove 83. The X-ray source 11 and the imaging unit 12 are opposed to each other. By sliding the X-ray source 11 along the first groove 83, the distance between the X-ray focus and the detection surface of the FPD 23 is adjusted.

In the base 82, a second groove 84 extending in a vertical direction is formed. The swing arm 81 is slidable in the vertical direction along the second groove 84 via a coupler 85 provided in a connection portion between the U-shaped member 81a and the linear member 81b. The swing arm 81 is swingable via the coupler 85 about a rotational axis C extending in the y direction. In taking the X-ray image of the lying patient, the swing arm 81 is swung from a state of imaging the standing patient as shown in FIG. 11 by 90° in a clockwise direction about the rotational axis C, such that the imaging unit 12 is disposed under a bed (not shown) for laying the patient. The swing arm 81 is swingable not only by 90° but also by an arbitrary angle, and hence the X-ray image can be taken in a position other than a standing position (horizontal direction) and a lying position (vertical direction).

In this embodiment, the swing arm 81 holds the X-ray source 11 and the imaging unit 12. Thus, it is possible to adjust the distance between the X-ray source 11 and the imaging unit 12 more easily and precisely than the above first and second embodiments.

In this embodiment, the imaging unit 12 is attached to the U-shaped member 81a, and the X-ray source 11 is attached to the linear member 81b. However, using a so-called C-arm, the imaging unit 12 may be attached to one end of the C-arm, and the X-ray source 11 may be attached to the other end of the C-arm.

### Fourth Embodiment

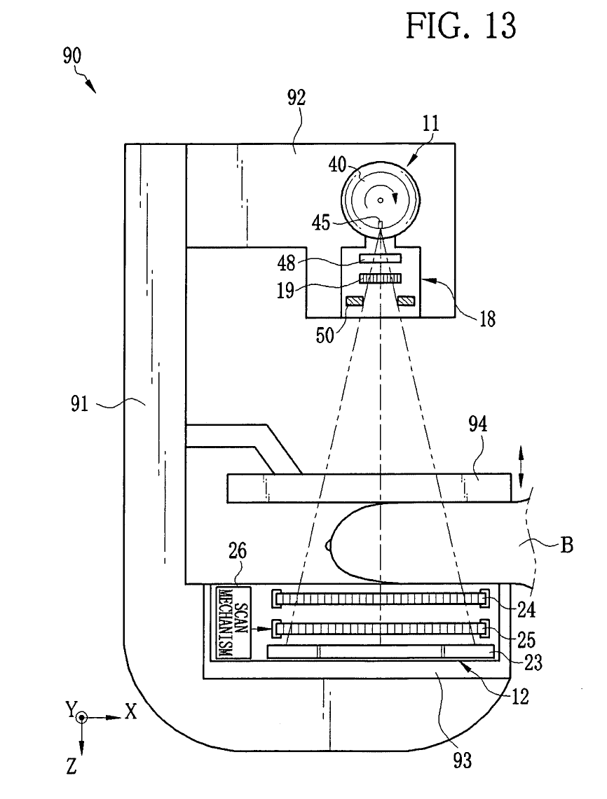

In this embodiment, the present invention is applied to mammography. A mammographic imaging system 90 shown in FIG. 13 takes an X-ray image (phase contrast image) of a breast B as an object. The mammographic imaging system 90 includes an arm portion 91 coupled rotatably about a base (not shown), an X-ray source container 92 attached to one end of the arm portion 91, an imaging table 93 attached to the other end of the arm portion 91, and a pressing board 94 movable in a vertical direction with respect to the imaging table 93.

The X-ray source container 92 contains the X-ray source 11. The imaging table 93 contains the imaging unit 12. The X-ray source 11 and the imaging unit 12 are opposed to each other. The pressing board 94 is moved by a movement mechanism (not shown), and catches and presses the breast B with the imaging table 93. In a pressed state of the breast B, the X-ray imaging is performed.

Since the X-ray source 11 and the imaging unit 12 have the same structure as those of the first embodiment, each component thereof is designated by the same reference numeral as that of the first embodiment. The other structure and operation are the same as those of the first embodiment, and detailed description thereof is omitted.

### Fifth Embodiment

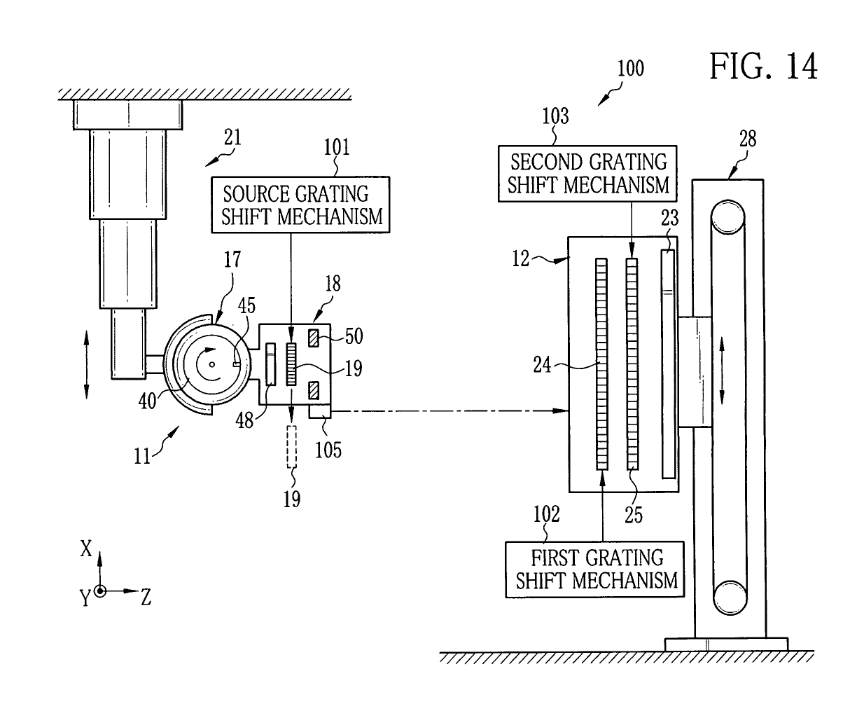

In a fifth embodiment, an X-ray imaging system 100 shown in FIG. 14 can take both of a phase contrast image and a normal absorption image. The X-ray imaging system 100 is provided with a source grating shift mechanism 101 for shifting the source grating 19, a first grating shift mechanism 102 for shifting the first absorption grating 24, and a second grating shift mechanism 103 for shifting the second absorption grating 25. In an absorption image taking mode for taking the absorption image, the grating shift mechanisms 101 to 103 shift the source grating 19 and the first and second absorption gratings 24 and 25 out of the optical path of the X-rays, as shown in broken lines in FIG. 14. In a phase contrast image taking mode for taking the phase contrast image, the grating shift mechanisms 101 to 103 shift the source grating 19 and the first and second absorption gratings 24 and 25 back into the optical path of the X-rays. The grating shift mechanisms 101 to 103 are controlled by the console controller 30.

The grating shift mechanisms 101 to 103 also have the function of rotating the source grating 19 and the first and second absorption gratings 24 and 25. This function is used for modifying misalignment among the gratings 19, 24, and 25, after the source grating 19 and the first and second absorption gratings 24 and 25 are backed into the optical path of the X-rays. In the modification of misalignment, for example, at least one of the gratings 19, 24, and 25 is rotated about any of x, y, and z axes passing through the optical axis of the X-rays.

The collimator unit 18 is provided with a distance measuring section 105, which measures a distance to the imaging unit 12 optically, for example. Upon switching from the absorption image taking mode to the phase contrast image taking mode, the console controller 30 commands the distance measuring section 105 to measure the distance between the collimator unit 18 and the imaging unit 12. The console controller 30 calculates present distances between the X-ray focus 45 and the source grating 19, between the X-ray focus 45 and the first absorption grating 24, between the X-ray focus 45 and the second absorption grating 25, and between the X-ray focus 45 and the FPD 23, based on a measurement result of the distance measuring section 105. The console controller 30 commands the X-ray source holder 21, the upright stand 28, and the grating shift mechanisms 101 to 103 to move the X-ray source 11, the source grating 19, the first and second absorption gratings 24 and 25, and the FPD 23, such that the above distances become appropriate in the phase contrast image taking mode.

Since the X-ray source 11 and the imaging unit 12 have the same structure as those of the first embodiment, each component thereof is designated by the same reference numeral as that of the first embodiment. The other structure and operation are the same as those of the first embodiment, and detailed description thereof is omitted.

In the above embodiments, the first and second absorption gratings 24 and 25 geometrically project the X-rays through the X-ray transmitting portions 24b and 25b, but the present invention is not limited to it. The first and second absorption gratings may diffract the X-rays by slits, and produce the Talbot effect (refer to U.S. Pat. No. 7,180,979 and Applied Physics Letters, Vol. 81, No. 17, page 3287, written by C. David et al. on October 2002). In this case, however, the distance L₂ between the first and second absorption gratings 24 and 25 is required to be set at the Talbot distance Zₘ. Also, in this case, a phase diffraction grating is usable instead of the first absorption grating 24. The phase diffraction grating projects a fringe image (self image) produced by the Talbot effect to the second absorption grating 25.

There are two types of phase diffraction gratings including a π/2 phase diffraction grating, which provides a phase shift of π/2 to the X-rays, and a it phase diffraction grating, which provides a phase shift of it to the X-rays. In the case of using the π/2 phase diffraction grating instead of the first absorption grating 24, the Talbot distance Zₘ is represented by the following expression (13):

$${Z}_{m} = ( m + \frac{1}{2} ) \frac{{p}_{1} {p}_{2}}{λ} \qquad ( 13 )$$

Wherein, m represents zero or a positive integer.

On the other hand, in the case of using the it phase diffraction grating instead of the first absorption grating 24, the Talbot distance Zₘ is represented by the following expression (14):

$${Z}_{m} = ( m + \frac{1}{2} ) \frac{{p}_{1} {p}_{2}}{2 λ} \qquad ( 14 )$$

Wherein, m represents zero or a positive integer.

In the above embodiments, the X-ray source 11 emits the cone-beam X-rays, but another X-ray source for emitting a parallel beam may be used instead. In this case, the Talbot distance Zₘ is represented by the following expression (15), if the first absorption grating 24 is adopted:

$${Z}_{m} = m \frac{{p}_{1}^{2}}{λ} \qquad ( 15 )$$

Wherein, m represents a positive integer.

If the X-ray source for emitting the parallel beam is used instead of the X-ray source 11, and the π/2 phase diffraction grating is used instead of the first absorption grating 24, the Talbot distance Zₘ is represented by the following expression (16):

$${Z}_{m} = ( m + \frac{1}{2} ) \frac{{p}_{1}^{2}}{λ} \qquad ( 16 )$$

Wherein, m represents zero or a positive integer.

If the X-ray source for emitting the parallel beam is used instead of the X-ray source 11, and the n phase diffraction grating is used instead of the first absorption grating 24, the Talbot distance Zₘ is represented by the following expression (17):

$${Z}_{m} = ( m + \frac{1}{2} ) \frac{{p}_{1}^{2}}{2 λ} \qquad ( 17 )$$

Wherein, m represents zero or a positive integer.

In the above embodiments, the object H is disposed between the X-ray source 11 and the first absorption grating 24. However, if the object H is disposed between the first and second absorption gratings 24 and 25, the phase contrast image can be produced in a like manner.

### Sixth Embodiment

In the above embodiments, the second absorption grating 25 is independent of the FPD 23. Using an X-ray image detector of U.S. Pat. No. 7,746,981 can eliminate the second absorption grating 25. This X-ray image detector is of a direct conversion type, which is provided with a conversion layer for converting the X-rays into the electric charges and charge collection electrodes for collecting the converted electric charges. The charge collection electrode of each pixel is composed of a plurality of linear electrode groups, which are arranged at a constant period out of phase with each other and electrically connected to each other. The charge collection electrodes compose the intensity modulator.

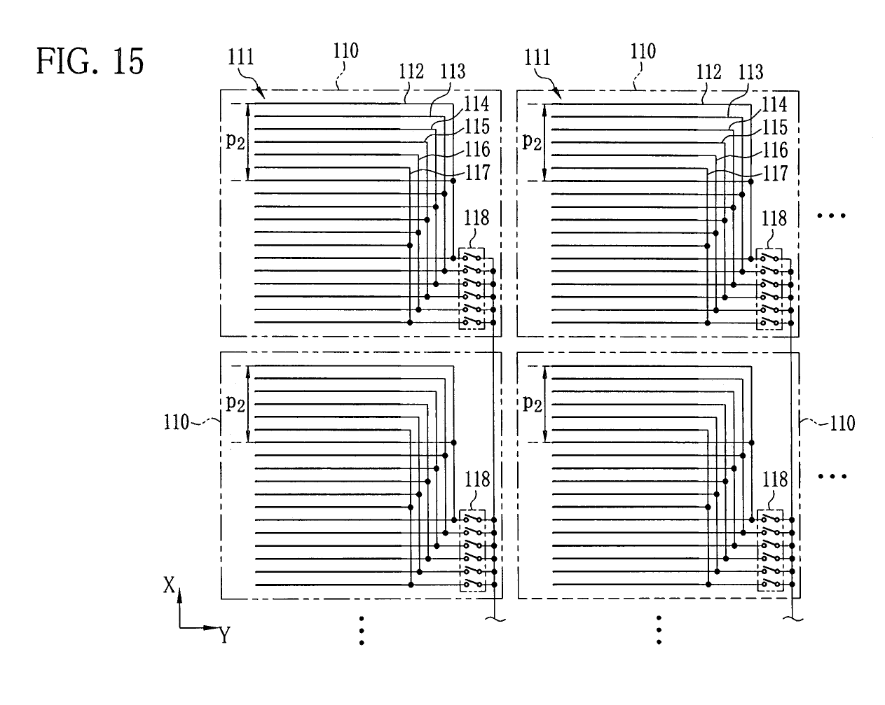

As shown in FIG. 15, in the X-ray image detector (FPD) according to this embodiment, pixels 110 are arranged at a constant pitch in two dimensions along the x and y directions. In each pixel 110, a charge collection electrode 111 is formed to collect the electric charges converted by the conversion layer. The charge collection electrode 111 is composed of first to sixth linear electrode groups 112 to 117, which are arranged out of phase with each other by π/3. To be more specific, when the phase of the first linear electrode group 112 is set at 0, the phases of the second to sixth linear electrode groups 113 to 117 are represented by π/3, 2π/3, π, 4π/3, and 5π/3, respectively.

In each pixel 110, there is provided a switch group 118 for reading out the electric charges collected by the charge collection electrode 111. The switch group 118 includes six TFT switches connected to the first to sixth linear electrode groups 112 to 117, respectively. The electric charges collected by the first to sixth linear electrode groups 112 to 117 are separately read out under control of the switch group 118. Thus, it is possible to obtain six fringe images out of phase with one another by a single imaging operation. Based on the six fringe images, the phase contrast image is produced.

Using the X-ray image detector having above structure instead of the FPD 23 eliminates provision of the second absorption grating 25 in the imaging unit 12. This facilitates reduction in cost and further slimming of the imaging unit 12. In this embodiment, it is possible to obtain by the single imaging operation the plural fringe images subjected to the intensity modulation at a different phase. Thus, physical scanning carried out in the fringe scanning technique becomes unnecessary, and the scan mechanism 26 can be omitted. Instead of the charge collection electrode 111, charge collection electrodes having the other structure described in the U.S. Pat. No. 7,746,981 may be used.

Furthermore, in another embodiment without using the second absorption grating 25, the fringe image (G1 image) obtained by the X-ray image detector may be sampled periodically with changing its phase by signal processing, to apply the intensity modulation to the fringe image.

In the above embodiments, the source grating 19 and the filter set 48 are fixed in the case 51 of the collimator unit 18. However, a source grating unit containing the source grating 19 and a filter unit containing the filter set 48 may be prepared separately in an easily changeable manner. Each of the above embodiments is applicable to various types of radiation imaging systems for medical use, industrial use, and the like.

Although the present invention has been fully described by the way of the preferred embodiment thereof with reference to the accompanying drawings, various changes and modifications will be apparent to those having skill in this field. Therefore, unless otherwise these changes and modifications depart from the scope of the present invention, they should be construed as included therein.

What is claimed is:

1. A radiation imaging system comprising:
a radiation tube for producing a radiation upon application of an electron beam from a filament to a rotating anode;
a source grating having a plurality of radiation shielding portions, said radiation shielding portions extending in a first direction orthogonal to an optical axis of said radiation and parallel to a rotational axis of said rotating anode, and being arranged at a predetermined pitch along a second direction orthogonal to said first direction; and
a radiation image detector opposed to said radiation tube, for detecting said radiation passed through an object.

2. The radiation imaging system according to claim 1, further comprising:
a filter disposed between said radiation tube and said source grating, wherein said radiation passes through said source grating after having passed through said filter.

3. The radiation imaging system according to claim 2, further comprising:
a collimator unit having said source grating, said filter, a beam limiting unit, and a lighting unit, wherein
said beam limiting unit is disposed downstream from said source grating in an application direction of said radiation and defines an irradiation field of said radiation; and
said lighting unit illuminates said irradiation field of said radiation by projecting light through said beam limiting unit.

4. The radiation imaging system according to claim 1, further comprising:
a first grating disposed between said source grating and said radiation image detector, for producing a fringe image by passing said radiation therethrough;
an intensity modulator for applying intensity modulation to said fringe image at plural relative positions having different phases from each other relative to a periodic pattern of said fringe image; and
a phase contrast image generator for generating a phase contrast image of said object, wherein
said radiation image detector detects said fringe image modulated by said intensity modulator; and
said phase contrast image generator generates a phase contrast image of said object based on a plurality of said fringe images obtained by said radiation image detector, from phase information modulated by said object upon passage of said radiation through said object disposed between said source grating and said first grating, or between said first grating and said intensity modulator.

5. The radiation imaging system according to claim 4, wherein said intensity modulator includes:
a second grating having a periodic pattern of a same direction as that of said fringe image; and
a scan mechanism for shifting one of said first and second gratings at a predetermined pitch.

6. The radiation imaging system according to claim 5, wherein
said first and second gratings are absorption gratings; and
said first grating projects said radiation emitted from said radiation source to said second grating as said fringe image.

7. The radiation imaging system according to claim 5, wherein
said first grating is a phase diffraction grating; and
said first grating projects said radiation emitted from said radiation source to said second grating under a Talbot effect as said fringe image.

8. The radiation imaging system according to claim 4, wherein
each pixel of said radiation image detector has a conversion layer for converting said radiation into an electric charge and a charge collection electrode for collecting said electric charge converted by said conversion layer; and
said charge collection electrode includes a plurality of linear electrode groups, and said linear electrode groups have a periodic pattern of a same direction as that of said fringe image and are arranged out of phase from each other; and
said charge collection electrode composes said intensity modulator.

9. A collimator unit used in a radiation tube, said radiation tube producing a radiation upon application of an electron beam from a filament to a rotating anode, said collimator unit comprising:
a source grating having a plurality of radiation shielding portions, said radiation shielding portions extending in a first direction orthogonal to an optical axis of said radiation and parallel to a rotational axis of said rotating anode, and being arranged at a predetermined pitch along a second direction orthogonal to both of said optical axis and said first direction; and
a beam limiting unit disposed downstream from said source grating in an application direction of said radiation, for defining an irradiation field of said radiation.

10. The collimator unit according to claim 9, further comprising:
a filter disposed between said radiation tube and said source grating, wherein said radiation passes through said source grating after having passed through said filter.

11. The collimator unit according to claim 10, further comprising:
a lighting unit for illuminating said irradiation field of said radiation by projecting light through said beam limiting unit.
